(19) United States
(12) Patent Application Publication
(10) Pub. No.: US 2013/0079073 A1
(43) Pub. Date: Mar. 28, 2013

(54) NEXT-GENERATION FANTASY FOOTBALL

(71) Applicant: Pejman Sharifi, New York, NY (US)

(72) Inventor: Pejman Sharifi, New York, NY (US)

(21) Appl. No.: 13/623,016

(22) Filed: Sep. 19, 2012

Related U.S. Application Data
(60) Provisional application No. 61/626,060, filed on Sep. 19, 2011.

(51) Int. Cl. G07F 17/32

(52) U.S. Cl. CPC G07F 17/32; G07F 17/3225
USPC 463/3; 463/42

(57) ABSTRACT

System, method, network, applications, devices, non-transient computer readable medium are provided that implement next generation fantasy sports feature in particular application to fantasy football.

The present application claims priority, under 35 U.S.C. §119(e) to U.S. Provisional Application 61/626,060, filed Sep. 19, 2011, which is expressly incorporated herein by reference in their entirety for all purposes.

### FIELD OF THE INVENTION

The present invention relates to advancements in electronic fantasy football games and fantasy sports games.

### BACKGROUND

Known fantasy football systems and fantasy sport systems have not evolved in any significant way since their inception. There is a need for improving these systems to evolve the user experience.

### SUMMARY

A system that implements an interactive electronic fantasy football game comprising one or more computers that provide or implement an interactive starting roster selection option in which the system is configured to permit team owners to interact with the system to select a starting line up in which one or more available positions is for identifying a player for a player position and also select one or more in-game context-related characteristic in association with the player position.

A system that implements an interactive electronic fantasy football game comprising one or more computers that provide or implement an interactive starting roster selection option in which the system is configured to permit team owner to select a player for a position and select down or other game situation to specify situation which the team owner will receive corresponding points for that player's actual player performance for playing during that down in a game or for that game situation to earn corresponding points for that player's actual player performance for play during that game situation. By specifying the situation in the selection, the system will limit the points earned by the team owner for that player and situation selection to the performance of that player in or that meets that situation.

A system that implements an interactive electronic fantasy football game comprising one or more computers that provide or implement one or more fantasy football features, comprising one or more computers that provide or implement an automatic starter replacement option that is configured to provide users with selection options that are used to select a player and a point-difference context to receive corresponding fantasy points for the play of a selected period when the point difference in a game is equal to above a specified point difference. Thus, the system can limit points earned to the player performance after the criteria is met.

A system that implements an interactive electronic fantasy football game comprising one or more computers that provide or implement one or more fantasy football features, comprising one or more computers that provide or implement a specialized clutch point complement to basic point system in which the point system awards points for clutch plays, wherein the system evaluates the state of the game in accordance with the point difference between the teams, the down, game period (half, quarter or overtime), official time left in the game or half, or combinations thereof and data representative of the play and determines that the state and data contains significant characteristic representative of a valued actual play or team unit performance.

The system can be further configured to reduce or discount points that are issued for performance of an actual play when the play has characteristics that match a poor performance in an important or clutch play.

A system that implements an interactive electronic fantasy football game comprising one or more computers that provide or implement one or more fantasy football features, comprising one or more computers that provide or implement an automatic roster move option that is configured to automatically replace a starting player on a fantasy team with another player while the owner of the team has been locked from making a roster move that would permit the owner to move the starting player from the starting player, wherein the system makes the move automatically when a certain condition is satisfied.

A system that implements an interactive electronic fantasy football game comprising one or more computers that provide or implement one or more fantasy football features, comprising one or more computers that provide or implement a feature that determines whether certain plays are clutch or highly valuable plays in which the system is configured to receive data corresponding to in-game variable estimation of a likelihood of a team winning a game or a point spread as the game progress and which uses that data to evaluate one or more player or team performance by corresponding in game variations in the estimation to player or team performance during a game such as one play, and generates a result indicating a fantasy point value based on the in-game estimation and its variations.

A system that implements an interactive electronic fantasy football game comprising one or more computers that provide or implement one or more fantasy football features, comprising one or more computers that provide or implement an interactive starting position selection option that is configured to provide users with the opportunity to select which quarters or halfs during which a player will be a starter and the team owner that made the selections will receive points for that player performance during the selected quarters or halfs, wherein a user will be provided to select at least one specific quarter or half and the system will award points to the user for that players performance for that players performance in that selected quarter or half As such, player performance of a starter that occurs in an unselected game period will not generate fantasy points to the team owner.

A system that implements an interactive electronic fantasy football game comprising one or more computers that provide or implement one or more fantasy football features, comprising one or more computers that provide or implement a time liner bar feature that that is configured to process data related to each player on a starting fantasy roster and generate a timeline bar that is displayed, wherein the time line bar is filled in correspondence to an amount of playtime that is completed by starting players on that fantasy team. The timeline can be the total number of official minutes in a game multiplied by the number of starting positions. An overtime for a starting position can cause the total time and timeline to be updated and recalculated.

A system that implements an interactive electronic fantasy football game comprising one or more computers that provide or implement one or more fantasy football features, comprising one or more computers that provide or implement a scoring notification feature that is configured to determine the scoring progress of a fantasy team during a match, detect whether one or more thresholds have been met, and send a notification to that team's opponent for that match to notify the opponent that their opponent has each threshold during that week's match.

A system that implements an interactive electronic fantasy football game comprising one or more computers that provide or implement one or more fantasy football features, comprising one or more computers that provide or implement a scoring bar feature that is configured to display a bar for a team's fantasy points scoring progress wherein the system fills the bar to reflect points generated by a fantasy team as the time progresses for that team's current match. The bar can include markers indicating mile markers in generating points. The system can display associated data that clarifies a current state of a fantasy team during the match. The system can include a graphical display such as bar or circle that is filled in correspondence with how much time is left to play for that team based on the playtime of its starting players.

A system that implements an interactive electronic fantasy football game comprising one or more computers that provide or implement one or more fantasy football features, comprising one or more computers that provide or implement an auto-coach feature that is configured to evaluate a team's staring line up and process status information about the starting line up and is further configured to determine which starters have a current status that significantly impacts the likelihood of generating points such as based on the players injury status, a bye week, or specific other trigger such as news, and automatically generating a signal or process in response that replaces those one or more starters with another player. The system can be configured to be an option that the team owner selects to activate. The system can be configured to only be available for the payment of a fee to activate the feature or a fee for each replacement move that the system implements.

A system that implements an interactive electronic fantasy football game comprising one or more computers that provide or implement one or more fantasy football features, comprising one or more computers that provide or implement a short term trade feature that is configured to permit short term trades between team owners, the system can include interaction options by which a selectable trade is executed, the trade involves trading one or more players between two team and the trade specifies a duration of the trade, and where in the system executes a transient trade which moves players between the teams and automatically reverses the trade at the end of the duration.

A system that implements an interactive electronic fantasy football game comprising one or more computers that provide or implement one or more fantasy football features, comprising one or more computers that provide or implement a skill points feature that is configured that includes a fantasy sports game that generates fantasy points for real life player performance and issues another type of points such as skills point that are determined by individual users interaction with the system by which the a user enters a prediction of one or more player, team, or game performance or outcome, wherein the system evaluates the accuracy of the prediction by comparison of actual results and issued skill points based on the accuracy and issues skill points in correspondence with the level of accuracy.

A system that implements an interactive electronic fantasy football game comprising one or more computers that provide or implement one or more fantasy football features, comprising one or more computers that provide or implement a trade assist feature that is configured that reviews fantasy teams in a league and based on player performance, projected matchup performance, and fantasy team rosters for each team generates a trade that is evenly balanced but which benefits the overall projected estimates for each fantasy team.

A system that implements an interactive electronic fantasy football game comprising one or more computers that provide or implement one or more fantasy football features, comprising one or more computers that provide or implement an attention catching and entertaining scoring interface that is configured and implements a graphical scoring window in which graphical elements create visual movements or color variations that corresponds to points generated by that team owners' fantasy team in that point period's matchup.

A system that implements an interactive electronic fantasy football game comprising one or more computers that provide or implement one or more fantasy football features, comprising one or more computers that provide or implement a weather adjusted player projection feature that is configured to adjust player projection of fantasy points using the weather forecast and displays the projection to a user to assist in player roster selections.

### BRIEF DESCRIPTION OF THE DRAWINGS

Further features of these and other inventions, their nature and various advantages will become more apparent upon consideration of the following detailed description, taken in conjunction with the accompanying drawings, in which like reference characters or terms refer to like parts throughout, and in which:

FIGS. 1-13 are illustrative flow charts and display windows demonstrating one or more embodiments of the present invention.

### DETAILED DESCRIPTION

The general principles of the present inventions are related to enhancing the player experience of electronic interactive fantasy football games. An evolution of fantasy games to a next generation of features will increase the interest in the game, add to the base of players, generate additional revenues, heighten interest in football as a form of entertainment, and provide other advantages. Many different variations and additional features of core and related implementations of core systems or methods are provided herein.

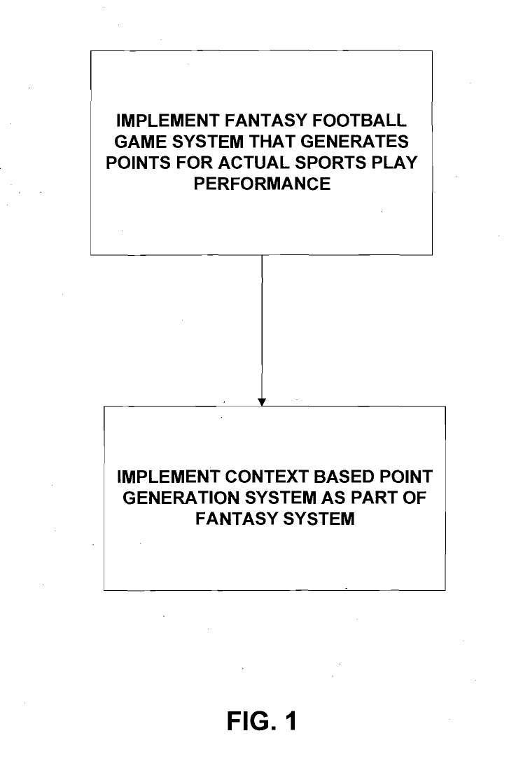

Existing games are deficient at least in the way that they ignore the highly situational aspects of the game of football and full game play. Existing games allow users to pick individual players on offense and sometimes on defense and sometimes allow picking a whole side (e.g., a user can select individual offensive players and a defensive unit of a team). This linear approach doesn't capture the excitement of the game, ignores advanced user skills, prohibits parity, and is one dimensional. It also ignores highly contextual nature and value associated with individual plays (e.g., a clutch play near the end of the game). As for example shown in the flow chart of FIG. 1, a system can be implemented that is configured to implement a fantasy football game system that generates points for a fantasy team using the actual player performance of a player on a users fantasy football team. The system can be enhanced by implementing a context based point system that generates context based points as part of the fantasy system. Context can be the ability to select a starter for different timer period (quarters), downs (1st, 2^{nd}, etc.), different situations (a high point differential—losing by 14 points), or other context as part of the process that the user is provided to select his or her starting lineup for a match up or upcoming scoring period. A context based system can include the ability of the system to evaluate the context of a player or series of plays and based on the context determine whether bonus points, increased points, or decreased points should be issued. Another context implementation can be an automatic feature that makes roster moves. The system monitors game data such as quarter, time elapsed, player performance, team scoring, other player performance and determined whether a condition or criteria is satisfied during a period in which a team owner is not provided with the opportunity to add a player from his team roster to the starting line up to earn points. If the condition is met, the system automatically makes the roster move to for example replace a starting player with another player form the owner's roster.

A situational roster approach is one new selectable option that can advance game play. Situations can be a particular down, particular distance for a first down, a game quarter, time elapsed/left in a game, two minute time frame (or thereabouts), a difference in score (e.g. being down by 14 points), weather conditions, or combinations.

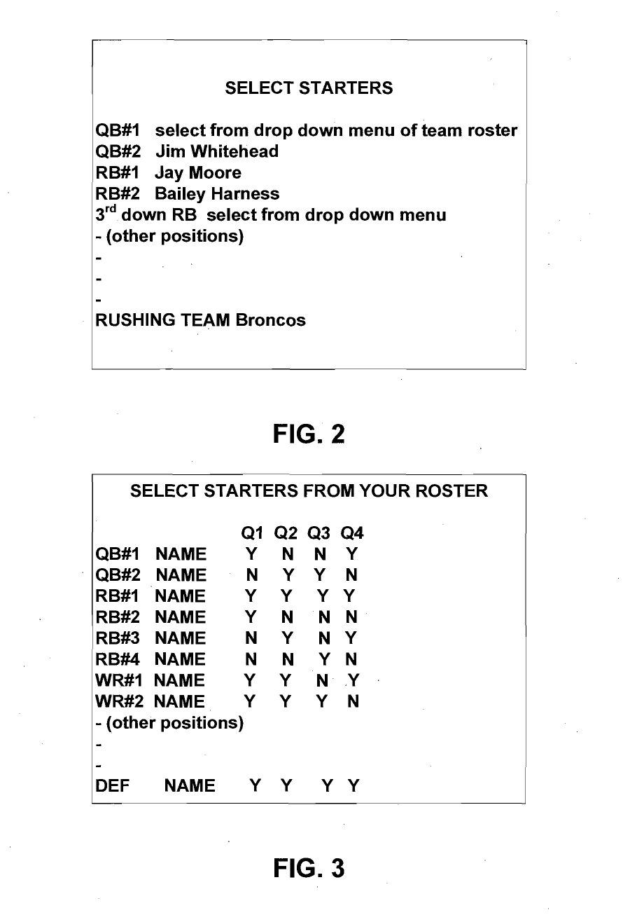

For example, as shown in FIG. 2, a roster position (or starting line up roster positions) can be included that is specifically for third down play by a running back (or for example a slot wideout or second tight end). A user can select to receive points for the play of that particular RB for third down play of that RB. A user may then be able to start Clinton Portis as a starting running back and Ladel belts as the third down back. Preferably, the user would not receive points for the third down play of Portis but would receive it for the third down play of Betts. If the user can select two or more RBs, then the option can be provided to two corresponding third down backs or can just be given to one third down back (e.g., linked to one or both of the starting RBs). The system would typically be setup to have one running back generate points for third down play and another player score for other downs. An alternative can be to have the option for the starting RB position to select a starting back and a third down back. A fantasy player can choose the same player for both starting RB roles or can choose two different players. The system can also provide the roster option of having a third down RB as being its own staring position. For example, the league can be implemented to allow a starting or activated roster to be made of two starting running back and one third down back. In this implementation, the system could limit the fantasy player to select a certain subset of running backs that are considered third down backs. The system can issue points for the third down back's play throughout the game. Alternatively, the system can issue points to the fantasy player only for the player's third down play of that activated back for the third down RB position.

As mentioned, in some embodiments, the user can also select the same RB for the starting RB and third down RB quarterback (picking twice even if they have other RBs available on the roster). In other words, selecting a RB for the one of those point issuing position may not remove the player from availability to be selected to be added to another starting RB position.

Further granularity can also be provided. For example, options to select starters can be provided for 1^{st} down, second down, third down, and fourth down. For example, a specific RB, WR, TE, can be selected for points from each down situation.

Selecting a the rushing play of an actual team can be an option for roster starter but it should typically provided without also offering starting RB positions in the line up. The same can apply for receiving.

The running back position is the one that is most apt for down based situational roster implementation. It could be applied to other positions as well. E.g., four wide out sets.

Another situation or context is a score differential. An RB may see greater play or less play depending on the point differential. The interactive option can be displayed, such as during the process of selecting starters for that week's games, to select to trigger a RB to be benched and activate (another player) to be the active player during a fantasy point accruing period when one of his or her starting running backs is in a game in which their team is losing by a particular point differential such as 14 points. The system can automatically substitute another back from his or her roster into the starting lineup. Another way to manage this is to always have links between certain RBs with a third down back (either in name or just as a label). e.g., team X has a certain starting running back but has multiple third down backs, the user would be able to have the option to select a starting running back by name and also select that team's (or a different team's) third down back(s) (e.g., your starting running back's actual team's third down backs) as a group to go with him onto the user's roster. The automatic substitution or addition feature can be implemented to automatically make a roster move to earn points from a player after the fantasy owner's team is locked or the player position on the team is locked. The system would then monitor game events and statistics and when a certain criteria (predetermined such as specified by a team owner) is satisfied, the system would automatically make the roster move even though the team or position is locked. The criteria can be set by one or more game parameters such as by a user or there may be a set of configurations (data reflects state) such as a significant lead, poor weather conditions, slow start, poor performance in half, strong performance by another position player (RB performing well may reduce potential points for QB, or other condition that can be evaluated by context data. The system would evaluate a set of parameters (one or more, e.g., price differential, quarter and interceptions, etc.) that specify the criteria or condition that will trigger the automatic roster move. The move will then will result in the team owner receiving points for the play of the added player (newly started player), preferable from the time that the player is added.

Another scoring option is to increase the points earned from clutch plays or reduce points based on the situation. For example, for a team that is ahead by 14 points, further scoring by QB or RB should be given a reduced (discounted) points e.g., for scoring a TD, the fantasy points would be 4 points as opposed to 6. Clutch plays such as an interception for a TD or a fumble recovery near the end of the game when the score is 8 points or less such as to take over a game, tie a game, take the lead, or bring the point difference closer to a real possibility of a comeback win should be awarded higher or bonus points. Other example of clutch plays include an onside kickoff recovery (to keep possession) e.g., when the point differential is close to make the onside kick important or a long TD run or reception in such situations should be awarded higher or bonus points. The context of situation of the play should reflect the point award. Further examples include a fourth down clutch interception when the game is close, a QB executing an 80 yard drive to tie or get ahead in the fourth quarter, blocking a game winning field goal, or a defensive stop in over time (turn over of the ball by punt or otherwise). In some embodiments, the league may have the option to include a clutch point option or it could be implemented across all leagues.

Another way to measure context can be to discount the point issued by the play of team or players on a team that is ahead by a significant amount (e.g., 14 points). The higher the point differential, the bigger discount for the points that they accrue. This can also be applied to yards gained when they are used for points in the fantasy game. Another contextual point can be to issue negative points for poor clutch play. For example, issuing negative points for a kicker missing a game winning or tying field goal. The system can be implemented to automatically analyze game statistics and apply the higher or lower points that are applicable based on context and display the results. The system can offer to the users the option to enable this feature. It can also generate a visual and/or audio cue or alert notifying the user of the increased or decreased value.

One way to determine the impact of a play or series of plays is monitor a system that is generating probabilities or odds of each team winning the game. For example, some existing systems allow for in-game live wagering such as by trading contracts or other measures, these systems update their projections in response to game activity. The data from these systems can be used to determine the impact or value of a game such as to evaluate valued or poor performance of a clutch play or for example to qualify a particular play as a clutch play (e.g., to qualify using that information alone or in combination with other data such as the context). For example, if there is sufficiently significant swing or increate in probability, that information can be used in awarding such points or qualifying one or more plays. One example is moving for example from “−3” to pickem. Negligible changes or small incremental changes should generally be considered to non-qualifying but there can be exceptions such as by using the data over an entire drive to evaluate the quarterback or a coach's performance. One advantage of this data can be that it delineate which individual plays had the most impact on the outcome of a game or a change in a probability of the outcome of a game. Data that would match a threshold would indicate that the play, or plays was a good clutch play.

Another system improvement is to implement context scoring and coaching at a quarter, half or other time segment. For example, this can allow a fantasy player to make playing/active (point earning) roster decisions for all or some playing positions by quarter or time segment (e.g., two minute drill). This has an element of being asynchronous because all the actual games are not played at the same time, so the player play is asynchronous, e.g., by quarter. As for example, shown in FIG. 3, the system can display an option for the users to make selections with respect to activated players per quarter and provide confirmation of such selections. The system would then indicate and analyze the data for the players and generate a corresponding output (issues points) as a function of the activated player for each selected quarter. For example, in such a system, a user can select to start one of their running backs in the first and fourth quarter of his game that week, another running back in the first and second quarter's of his game and a third running back for the first, second, third, and fourth quarters of his game. This would be the same as having two starting running backs from a fantasy system perspective. Preferably, the system establishes limits on the total number of quarters or halfs that can be selected such as for a particular position by doing this competing fantasy teams are competing based for example on running backs in a total number of quarters for each team.

Other advancements relate to fantasy scoring alerts or indicators. The system can be configured to send alerts as your match opponent hits mile markers such as scoring levels. In one concept, there is a measure such as a bar for each fantasy team in the match. The bar can start hollow and is filled progressively as each team's player positions complete their play for the point period. The bar corresponds to how much corresponding play is left in the team's players. The bar could display at preset intervals the number of points that was earned at that interval. This way teams can view progress earned point in correspondence to how much potential point earning has occurred and is left.

Advancements can include a time line bar. For example, a bar predicts timeline of game ending taking into accounts the way football plays and time runs, game estimated to end at 4:15. Another time line bar or visual indicator can give a visual indicator of how much approximately game play is left for an active roster/teams current match.

In some embodiments, the system displays to the user that user's graphical display of time bar or points bar and does not provide or display the score or scoring progress of that user's competitor. Otherwise, the scoring is in the “blind” until a final score is determined or at some other predetermined event. For example, a user can see his or her team's performance and only receives notification or alerts that his or her competitor has achieved certain milestones (e.g., your opponent has now scored 100 points, your opponent has now scored 125 points, your opponent has not scored 135 points). Preventing a player from know the state of his or her competitor during a match can add to the excitement of the game. Incremental disclosure of state can also increase the excitement.

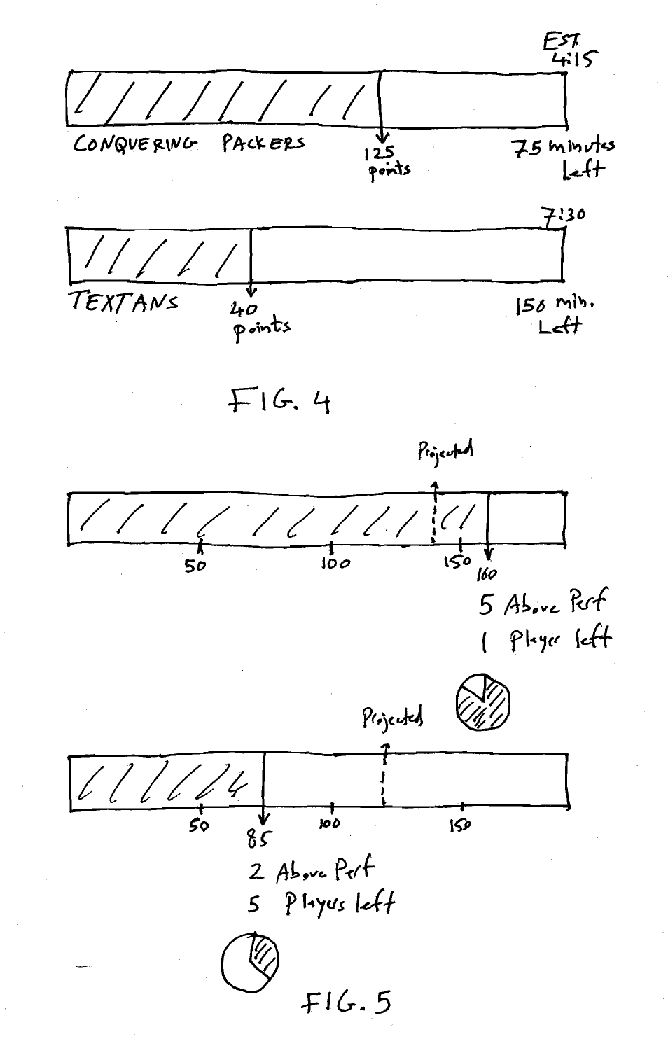

As illustrated in FIG. 4, a time line bar can be shown for each team in a match in parallel and corresponding positions for ease of comparison. If desired, a single bar can be displayed for that user's team for this or points bar. The bars are filled to show how much total time has elapsed for the available playtime for the starting players on each team. The display can be generated to show the total time remaining or elapsed. The display can be generated to display a numerical value or include some indicator displaying the total points scored thus far in conjunction with the elapsed time.

As illustrated in FIG. 5, a point bar can be shown for each team in a match in parallel and corresponding positions for ease of comparison. The bar can include a marker that displaying the points that were projected to be scored by that team (e.g., prior to the start of the point game). The bar can be display with additional information in text or graphic format. The additional information can be displayed to inform the user of the numerical value of the total points scored thus far, how players have performed or are performing above the projected performance for that player, how many players are left to play, start, or finish their game, and how much time is left for the fantasy team. A graphical indicator is show that display in a circle how much time is left for that team. The display can be filled in the same was as the time line bar. A timeline bar, a smaller version, could be used as opposed to that graphic.

A trade calculator can also be implemented. The system will be able to project the impact of a trade based on players added or dropped. The system will evaluate known player information and apply it to remaining schedule of play and provide an output of points increased or decreased over the schedule (e.g., the player seeking to be added or dropped may have several favorable games and the system will predict the proper impact of those games in the total calculation). In addition, the calculator can incorporate other factors such as a QB and WR being on the same team and accounting in the projection in the potential positive impact of such a situation.

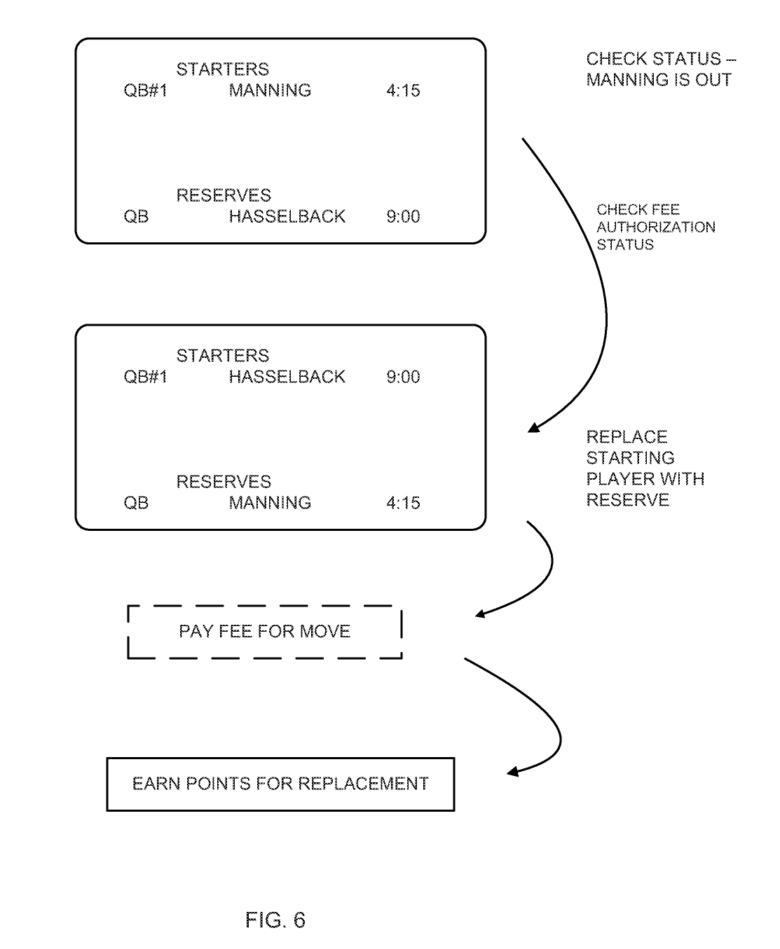

An automatic feature can be implemented that is set to automatically replace a player from your starting line up that doesn't start with another player. This avoids the gotcha when someone is pulled or injured. This feature or other auto-coach features can be provided as a premium service for a fee. For example, at the time a line up is locked or a player position on the team is locked (game starting) by the system, the system determines the starting quarterback is out due to an injury, the system automatically replaces the quarterback with another quarterback from that fantasy player's roster of players. The system may potentially have limited options and if not possible replacement is available due to time of game or other factors, the roster move is not implemented. The system can verify before or in conjunction with the replacement whether fee authorization exists for carrying out such an operation. This may have been a season for activating the “auto-coach” feature or it can be authorization to pay a fee for an individual move (each individual move). See also for example FIG. 6.

A short term trade option can be implemented. A trading option that permits users to choose to offer and accept short term trades can be implemented. For example, a player would be able to offer to trade Matt Ryan for a temporary period such as one, two, or three weeks. The counterparty would exchange a player such as a running back such as Stephen Jackson and the two parties after exercising the trade would receive the points earned from that received player while they are temporarily on their team. At the expiration of the time period set by the trade, the players would automatically revert back to their originating team.

Another example would be a short term trade but not for another player. A player can offer the temporary services of their fantasy player such as for two weeks for some form of “value” other than another player such as points earned from fantasy play.

Value can include the following electronic forms of value such as points or rewards earned from playing the fantasy game (e.g., if one fantasy team is ahead on points and has an injury to one of team's players, they can use some of their points fill a rosters position with a temporary fill-in from another team), sell their matches (a team/owner could sell an upcoming game, e.g., favorable match up to another team/owner such as if team X will be playing team Y in three weeks and Y may be a very weak team, X could sell that match up to team Z for a trade of a player so that Z would be matched up against Y in three weeks, not X), draft position, in-system perks, access to applications or networks, short term use of a premium service to another owner, a posting such “Z is the greatest fantasy player in the world,” first rights to receive a trade of a certain player (which can establish a queue), trade a player permanently for a temporary trade of a player, other value or combinations thereof.

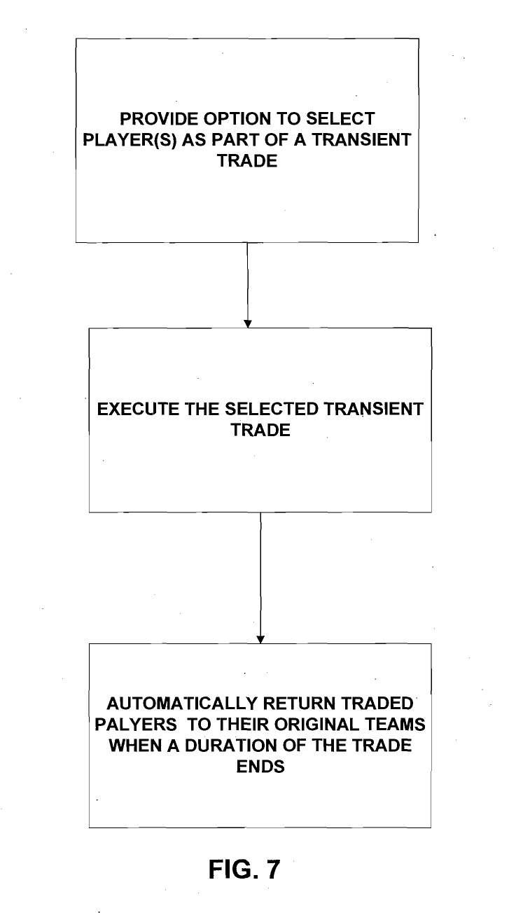

An illustrative process is shown in FIG. 7 for a short term trade feature. A selectable option for starting trades is provides with the display screens of the system. A team owner can select the option and select one or players for a trade. A second team owner can do the same or can rely on input by the first player. The trade specifies that it is transient or is selected to be transient. A user preferably selects displayed options that permits the user to specific or timeframe or a duration (or other trigger) of the trade such a number of games. Preferably the trade is for less than the amount of season left to be played. The system executes the trade and each team would then earn points with the traded player on the team. The system would monitor the transient state by for example generating a trigger when the duration or other trigger event has been reached. The system in response would automatically reverse the trade and return the players to their original teams.

The system is to configured to allow the user to change the alert setting from within an email application. More specifically, the user may have a newsfeed generated by the fantasy sport application. This could be automatically generated for his players or for designated players such as possible free agents. A designated form of receiving the news would be email. The receiving user can respond back to the newsfeed email such as writing “priority” (or some other code such as a desired state designator) in the email message body or elsewhere. The reply message is sent back to the fantasy sport application. In response, e.g., “priority” designator received, the fantasy sport application changes the alert or newsfeed setting to a different form or state such as by changing to SMS. For example, if a player receives a newsfeed for Matt Ryan and his injury status is relevant for an upcoming start, by responding to a newsfeed email with “priority,” subsequent alerts or newsfeed will be sent to the user's SMS address, which will likely have the greater attention of the user. The fantasy sport application can automatically reset the priority setting after each week's game or after each game of that player. The fantasy sport application can also send a confirmation email to confirm the change in the setting so that the user can understand that the setting was changed and understand other related parameters such as the duration for the change, e.g., priority status change confirmed for Matt Ryan (or all news or subset) to SMS until X date.

Provide an interactive option(s) that permits the user to customize a fantasy sports newsfeed such as for the team owned by the user. The user can set keywords (typed by the user) by themselves or in combination with the players on their team or designated players or actual sports teams or leagues. The parameters are applied to a search engine and the resulting news information is provided to the user as a feed in the fantasy application or in an email or other message sent to the user.

A user may have an ongoing email chain or network of fantasy or sports interested friends. A user may also have a social networking page such as one on Facebook for their personal friends. There is often a disconnect between fantasy sports and these communications even though the user may want to integrate or be better off by integrating them. There is a separation in application that can be one obstacle. An option can be provided that the user can use to select to feed their own personal communications channels into the fantasy sport application. For example, a module can be implemented which the user can trigger to pull an email chain from their email account (e.g. work email account in Outlook or personal account in gmail) into the fantasy sport application, the primary interface for this fantasy play and the module would then continue to feed any continuing communications into the fantasy sport application. An option would be automatically delete the pulled newsfeed from the email account form which it was pulled. Another feature may be to be able to pull into the fantasy application specific posts from a social networking site. For example, a module can be implemented to identify posts based on keywords or tagging and that can be run continuously or periodically to pull in those posts into the fantasy sport application. Another example can be a user having a page within a facebook page that is dedicated to his or her interest in sports or fantasy sports. The activity in that page can be automatically pulled into the fantasy sports application. If desired, these personal feeds moderated by friends can be combined and integrated with third party newsfeeds. Personally set filtering feeds can also be applied. A further option can be for the fantasy application provider to gain advertising revenue by controlling the order in which feeds are displayed or provided to users, e.g., news (e.g., third party) for a particular day can be organized such that third party providers can pay a fee to be at the top of the list, be somehow highlighted, be rotated, or randomly updated each time they are displayed.

A data feed of personal athletic performance can be combined with fantasy sports to have a combine score. The combined score can be the basis for a new form of competition where, for example, each player has to include their personal or personal team athletic performance (and earn point therefrom) with a fantasy sports points earned. The points from personal performance can be combined with fantasy points for each week's matchup to reach a total number of points that is used for example to determine the winner of that matchup.

The scoring interface of the system can maintain a limitation such that only a personal user's scoring information is displayed to the user and the scoring of other league member is blocked for viewing. The system can also be configured to display a scoring calculator when certain trigger events occur such as the team reaches a mile marker, an advertisement is played in a live game, or every 10 minutes.

The system can be configured to maintain a user's own line up or its match up opponent's line up or scoring status or a portion there of blocked from being viewed. For example, the system is configured not to not allow other teams to see your line up before they are in play and also while they are in play. If desired, in conjunction the system can provide mile markers triggers to tell people when they reach or their opponent reaches certain numbers (an element of uncertainly because you do not know if or when you are on solid ground or how far along the other teams roster is along in generating points for that day. For example, the system can alert you with an email or other onscreen popup that your opponent hit a scoring mile marker (e.g., 100 points) but withhold other information from which the user can assess whether your opponent has the potential earn much more points or has reach essentially the end of its resources. For example, the number of players that are left to complete their playtime is left undisclosed in viewable portions of screens in the system to prevent the user to determine the remaining strength of its opponents team. The lock may be removed when, for example, all of the players or almost all have completed their playtime opportunities.

The system can be configured to provider “zappo reverse” option. This is an excitement building short term option; this option can be exercised for example for a single matchup with an opposing team. The two users can swap players for that week but possibly doing so without knowing the other players lineup. When a user for example offers the swap, the players for that fantasy team are locked into its starting line up and have to be that players starters if the swap is not accepted. Alternatively, the swap is only available after a lineup lock deadline is passed. A user can offer to trade its starting running backs for his or opponents starting running back or other starting positions (two WRs). Two QB for a starting WR (first slot) and staring RB (second slot). Other value can be mixed in to make the possibility of a trade more interesting. When the match up ends, the swapped players remain in their original team. The excitement possibly has to do with that the deal is in the blind and a user may be able to strategize about the particular players and matchups to get an edge.) A whole team can be swapped as well if desired. The interactive can only be made available between two teams that play each other next. To further clarify, the system is configured for an option that gives two players in a matchup to select blind swap feature. Each user would have selected and locked it staring lineup and may have information about his or her opponent's general roster but the opponent in the fantasy match do not know the other player's starting line up. The blind swap to reverse positions is made for that week's matchup. The swapped players return to earn points for their originating teams when the matchup ends.

The system can be implemented to provide features related to proposition/skill points and/or hedge play. For example, the system can be implemented where a second set/type of points such as skills points are awarded. The user can be awarded skill points for certain activity. One way to earn skill points or to earn points in general can be to be able to accurately predict the performance of a team, players, offense/defense, passing, kicking, etc. For example, an option can be displayed that allows the user to be able to input his or her prediction of how many yards or touchdown (or other performance) a player will accomplish. The closer the user is in the estimate to actual performance, the better the points earned or the father the user is from actual performance, more points are deducted or factored down from the user. This could also be specifically only for skills points in conjunction with fantasy play. The system can also specify a threshold performance number (100 yards rushing) and the user will have to select whether the player will reach above or below that number. Selecting correctly can provide the user with points or skill points. This allows the user to possibly earn points by using their skill and knowledge to hedge a poor matchup such as when the user has no other options to start another player.)

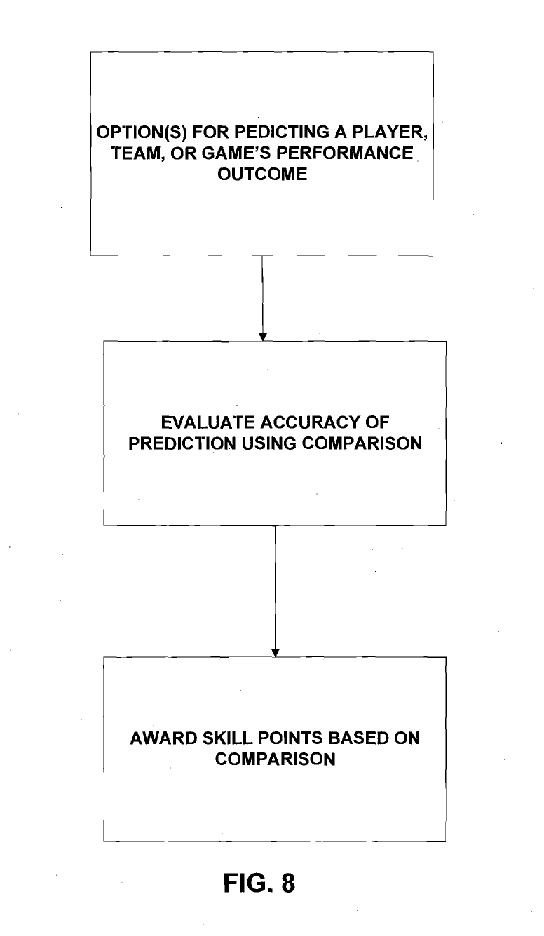

For example, a system can be implemented to award a second type of points, skill points that is awarded for activity other than the fantasy points earned from actual football players performance in their real life game. The skill points is a different category of points that is issued to the skill of the fantasy team owner in predicting actual player or team performance. One advantage here is that a team owner may find itself with a poor roster, but can demonstrate his or her skill by showing that he or she can accurately predict performance or outcomes. The skill point can be combined with fantasy points to determine matchup winners or used in other ways. An illustrative process related to some embodiments of this feature is shown in FIG. 8. If desired, the skill points can be implement to increase parity by being a required component of the match up and are used to add or modify each teams total score based on the skill point.

Options related to defense-offense head to head functionality can be implemented. There is a general disparity between how fantasy sports treats the performance of defenses as compared to offenses. An interactive option can be provided that provides a head to head type functionality during a particular matchup. For example, a fantasy teams defensive performance can be applied as a deduction or multiplier (or fraction) against offensive scoring. For example, fantasy team of owner A may have total offensive points 100 and in matchup with fantasy team owned by B, B's defensive unit can have total defensive points 125. Those defensive scoring can be applied to change A's offensive points such as by dividing 100 by 125 to reach A's actual offensive points for that match. The application of points can be by category each passing, rushing, special teams, turnovers. Other forms of scoring can used to increase the importance of defensive play (examples provided herein) or points can be made higher for certain defense accomplishments e.g. a an interception for TD is 9 points as opposed to 6 or 7, which is typical, because it is a huge play and rarely occurs.

Features can be implemented to increase parity within a fantasy league. Prior art systems often times controlled parity by changing the order of the team rights in the waiver wire but this is typically insufficient. Other ways of achieving parity such as additional ways of scoring points, the mentioned defensive scoring option (typically defense trades are more available), temporary trades, allowing users to offer other value for trades, and other options described herein can increase parity and interest.

An option should be provided for scoring points from punts. Points to be earned if the punter gets the ball within the opponents 10 or 20 yards line and points for distance if the punt is from punter's own territory where marksmanship to get it within 10/20 is not important. As in other examples, additional or higher points can be awarded for clutch plays such as punting from within own end zone.

An auto-summary of league events can be implemented. Most leagues and fantasy applications just present individual users and leagues with raw data about the leagues and standing. At most, some auto-generated estimate of player performance and spread/line is generated from estimated performance. An option can be provided by the fantasy sports application that automatically generates a league news article or overview for the league. An application can automatically analyze and report on how far back teams are with respect to point differential from the first place team. The application can also state whether based on current trends whether a team can climb up to match or pass the first place player. The application can automatically analyze the leagues playoff rules and generate current qualifiers and then give points and analysis of which teams have a realistic chance of making it into the playoff. These will be generated into words and sentences to summarize the situation. This will avoid a lot of time spend trying to figure out the raw data on a week to week basis.

An auto-match-maker feature can be implemented. One of the drawbacks of existing systems is that individuals trades often time require a first user to figure out and identify a trade and then to approach another player for a trade. An automatic trade identifier can be in place that automatically scans the teams and identifies trading opportunities and suggests specific trades to teams. Individual users can follow through with the trade, alter the trade, offer other value through the sports fantasy application to be able complete the trade. The application may use a need indicator (secretly or publicly set by a user) to generate its trade offers. A third party or a league commissioner can also take over this role as a third party to stimulate the trading activity. If desired, this could be an add-on service such as having the fantasy vendor's staff act in this role or hiring someone to act as this role.

A system can be configured that reviews fantasy teams in a league and based on player performance, projected matchup performance, and fantasy team rosters for each team generates a trade that is evenly balanced but which benefits the overall projected estimates for each fantasy team.

A first right on a trade feature can be implemented. Often times users are frustrated because a trade occurs without the user having an opportunity to make an offer for that same player to join that users roster. A feature can be provided that allows users to select a first right (e.g., a queue of first rights) for a particular player, side, etc. For example, when a player is drafted or during the season, a user can select an option to have the first right for a trade of Randy Moss. Others can have the right in the queue. When the owner of Randy Moss finds a trade for Moss with another owner. The user that has the first right to Moss will be given a chance to offer a trade (e.g., after seeing the trade agreed to by the other user for Moss). Moss's user can now consider that offer as well and/or can consider as many of such offers by those having rights in the first rights queue for Moss. Different systems for selecting first rights can be applied such as giving each user a limited set of first rights to select, e.g., three or having a secondary draft for such rights or having unlimited such rights. It could also be a premium services that a user can obtain by paying an additional fee for the service or for each player or side.

Being able to select a team (rushing yards) as an alternative to two RBs can be a configured feature in the system. A deficiency in fantasy football is lack of value attributed to offensive lines. Another deficiency is lack of user's being able to try to follow a team that they are fans of Another source of excitement and scoring can also be provided. For example, an option can be provided that allow users to pick an individual teams rushing performance for a week. This could be in addition to having certain starting running backs or it could be used as an option within the league to choose between starting two RBs or starting a team's rushing performance. There is also an option of nonlinearity and increased competition here because there is a chance for two users earning points from the same teams rushing performance, once as a team and another by picking certain RBs for performance. A similar option can be provided for other situations such passing or receiving. A system can display an interactive option that permits the user to selection rushing yards or rushing performance for a team as a starting position in its lineup for the week's matchup. Select a team to receive its rushing yards also emphasizes the importance of offensive lines of a team rather than the individual performance of a player. The can be extended to other categories such as passing yards.

The system can be configured to permit players to wager on points earned. This can give players the option to increase the risk and excitement by using their earned points to risk in matchups. For example, two teams can agree that the winner takes all the points from the both team's points earned for the matchup between the two teams. Or for example, each user in the matchup can also choose a number to wager, e.g., 25 points if I win. An option to select offers within a matchup can also be provided such as I will have more rushing yards than you for 25 points. The system can be configured to provide options or display screens from which users make selection that input a wager, the basis for determining the outcome of the wager, and the amount of points wagered. The points won are preferably deleted from the losing player's total points and added to the winning player's total fantasy points. A limit can be implemented that permits a player to obtain too many points using this method. An option can be useful for adding interest when a team appears to be too far behind to win the league or qualify for the playoff This can provide catch up opportunity for teams. In one embodiment, the option can be limited and be made available only after the season has been played for a number of weeks such as turning it on near the end of the season (e.g., three weeks remaining in fantasy season).

The system can be configured to link the team owner's scoring page with individual plays of that owner's players or scoring plays so that a user can click on an icon and see the individual highlights. This provides an integrated page or screen or view of your teams video for a week or game, or longer period.

An option to integrate coaching decisions into point scoring by picking a coach. For example, selecting to go for a first down on a 4^{th} situation and making the first down, would be given scoring points for the coach. It could also be the selection of a coaching staff One way to earn points would be to award coaching points if a team covers game line spread. Other ways to score may exist.

The system can be implemented to include a visual display in which it shows your players images and indicates which are currently in the game, by for example, showing a helmet on that player or in association with that player.

A system can incorporate a different/third party in the environment. The third party can be an agent that has a roster of players as clients. The agent can be issued points which are stored for the agent based on the value of the player (e.g., each player may have a price). The agent may initiate trades for moving a player from a team and then agree and move a player. This can be implemented such that the team owner does not have control over the trade (the agent can move the player without owner of the team agreeing to the move). Owners can provide points or other incentives to keep players (make offers to the agents). Agents earn points as a percentage of the deals that they make.

An entertaining user interface can be implemented that combines different graphical displays or components to illustrate and generate a user's score (e.g., fantasy sports score). People have this curious desire to view colorful spinning or other active displays such a screen savers or even a slot machine scoring or spinning; there is also a like for viewing things climb or build to see if they reach a peak or trigger another event; there is also a point of gratification from positive feedback and stimulation, these concepts can be combined in a scoring window that adds up the user's scoring using different colorful (changing), moving components, shifting, climbing, swirling, or other active graphical items that correspond to the users scoring and increase their speed or pace as the score goes higher and higher or if it reaches a certain bonanza threshold. The system can also implement interface that rings, whoops, plays catches audio blurbs or dings as it counts up your point.

A system can be configured to include a scoring window within which the user displays a graphical display with different graphical components that visually changes in correspondence with the points generated by the fantasy team, the player that scored the points, the time during a game or overall game play that the scoring occurred, or other events that have proximate correspondence to the scoring activity. The window can be configured to include spinning wheels (trigger off/on to generate points), climbing poles or hills, flashing lights, bouncing walls (e.g, bounces pinball), or game type interactive that can be used to gradually illustrate the scoring of the fantasy team. A random point generator can be implemented such as at the end to randomly increase or decrease points awarded as an option if desired. The feature can be similar looking to pinball or other motion type game.

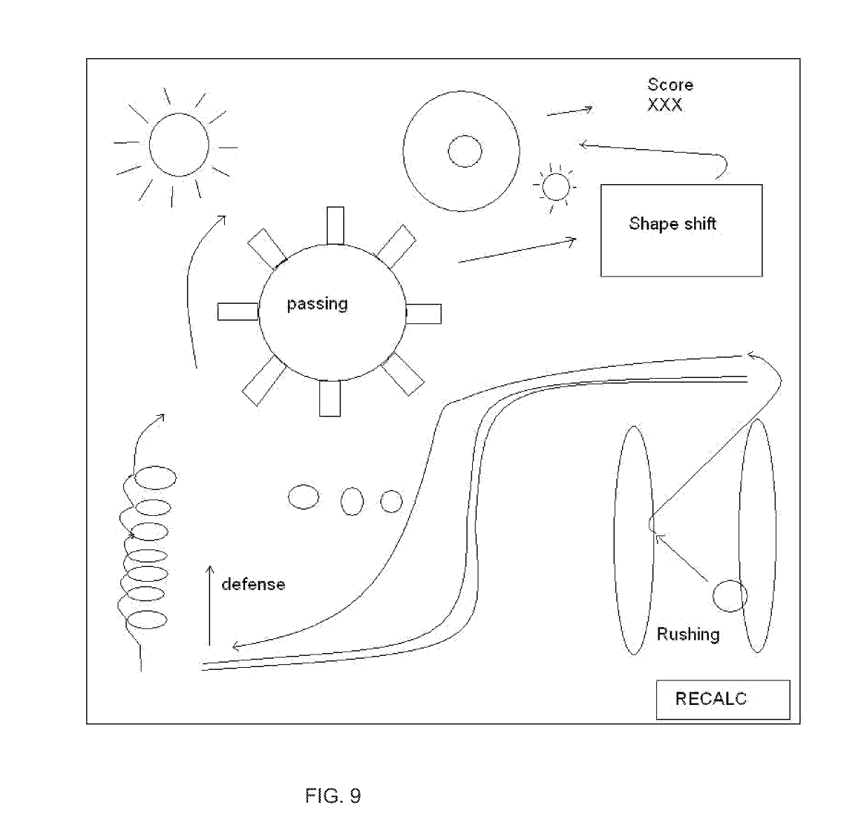

For example, as shown in FIG. 9, the system can display a scoring window that includes an arrangement of components that predetermined or randomly implemented on the display. In this embodiment, a ball or other playing piece moves between different component and in each section carries out activity that may correspond to points earned. For example, it may bounce 5 times between walls to reflect 50 points rushing and spin 10 times on the spinner to reflect 100 points of passing. If desired, each component can correspond to a fantasy point position or category of points (e.g., passing or starting QB). The activity on the window can correlate to the teams scoring and may be displayed gradually such as in a pinball or videogame to increase interest. A randomize can be the component such as target that is hit by ball and breaks. The resulting display shows how many random point are added for example.

A recalculate feature can be implemented within scoring interface permit the user to select spin/recalculate button to see again how the scoring adds up and to retrigger the motion, color, activity, and excitement of the scoring display calculator.

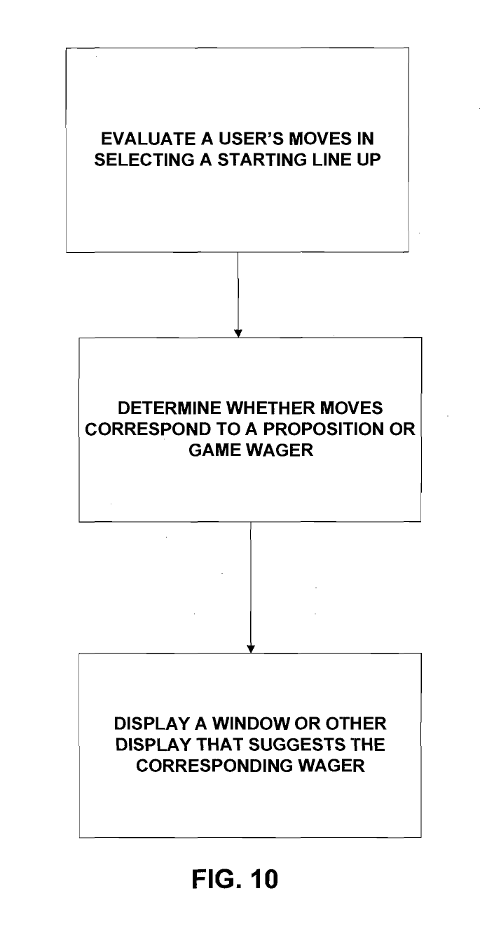

As illustratively mentioned in FIG. 10, a complementary waging systems can be implemented. The fantasy football system can be implemented to evaluate a player's moves (roster changes, waiver pick ups, etc.) in selecting a starting line up for a week's match up. The system can determine based on the evaluation whether the moves correspond to a proposition or game wager. For example, selecting a particular QB to be the starter for that week may indicate a belief that the team will have a strong performance. The system may be further configured to perform the evaluation by looking at other moves or moves not made such as picking one QB over another that is projected to have a strong week. The selection indicating the player believes the QB that is selected over the other QB will have a stronger week. The system will then display a suggestion such as a window or popup that suggests a proposition for the play of that selected QB or a game wager that QB's team will win or cover the spread. Selecting the wager will then follow through with a process of entering a wager.

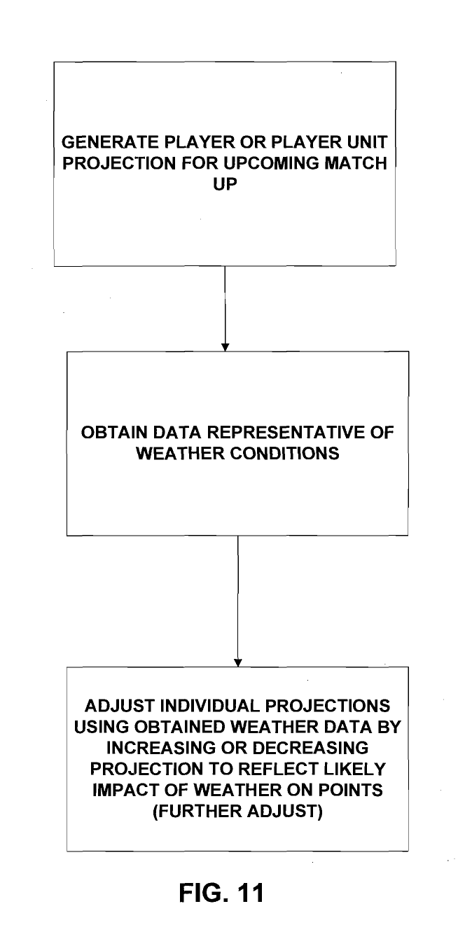

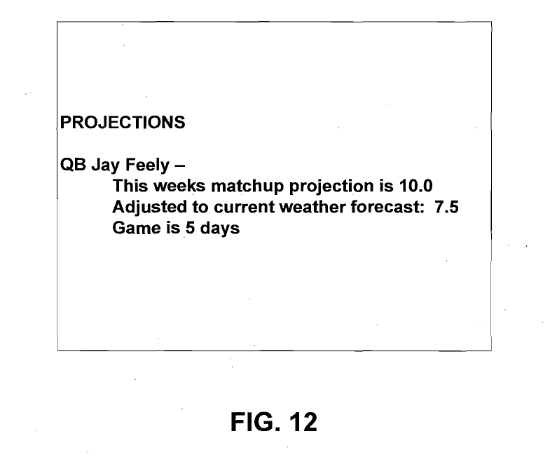

A fantasy football system can be implemented that makes helpful advances by incorporating a weather forecast into the projection of player performance in an upcoming match. For example as shown, FIG. 11, the system can be configured to generate player or player unit projections for an upcoming match up. The projections are provided to assist users tin making starting roster decisions for the upcoming match up. The system can obtain data representative of weather conditions that are forecast to occur during the upcoming match. The system can adjust projections using obtained weather data by increasing or decreasing projections to reflect the likely impact of weather on points. The system can update the projections with updated weather projections as the game draws closer. For example, the projection for a starting QB can be significantly reduced if the forecast is for heavy snow, wind, and cold conditions. The system may reduce the projection by 75% for example: For example as shown in FIG. 12, a display screen in the system that is displayed for a user can display the projection for that player and/or display the adjusted projection that is generated because of the weather forecast for weather that will likely occur during the game.

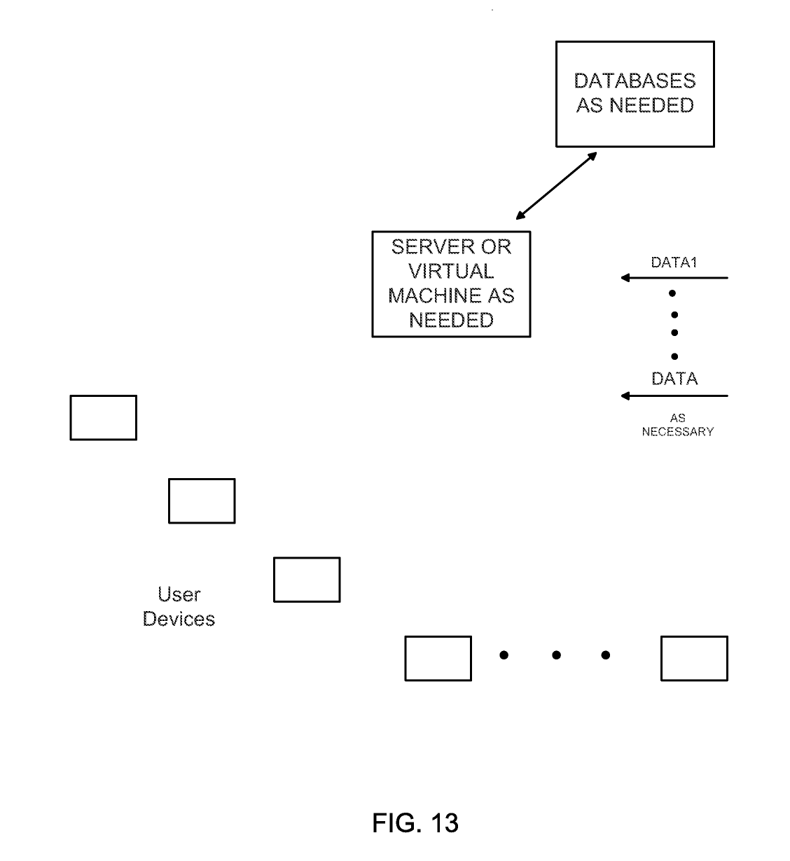

FIG. 13 provides an illustrative example of components for implementing fantasy football features or implementing such systems, processes, or computer readable medium over one or more of such components. As shown, user devices such PCs, mobile devices, or other end devices for providing interactive user features to user can be implemented. The devices can communication with each other and/or with one or more networks. A server or virtual machine can be implemented depending on the desired configuration to store software and provide resources for providing the fantasy features can be implemented. The server, virtual machine, and end devices can, if desired, work together to provide one or more of the fantasy football features. Connectivity can be by one or more known methods such as wireless, cloud, Internet, private, LAN, WLAN, wireless telecommunications, data networks, or other form of communication or medium. Data sources can be used to receive data for use in providing fantasy football features such as football statistics, wagering lines, multimedia, contract wagering data, user data league data, news or other data. A database can be implemented, for example on separate devices or as part of the server or virtual machine to permit the system to store and retrieve data necessary in providing fantasy football features as for example described herein.

An early fantasy football patent seems to be U.S. Pat. No. 4,918,603.

Systems and processes described herein can be implemented using computers over networks such as the PCs and Internet. Conventional fantasy football servers and systems can be configured to implement the above systems and process such as the interactive tools specifically describe above. Existing system can provide statistics from games and that data can be used in implementing the systems and methods described herein. For example, in some in stances, the statistics are evaluated using an algorithm that determines context and based on the algorithm determines the appropriate points.

One or more features illustratively described herein can be implemented individual or in variations combinations to enhance game experience.

The present system, method, or related inventions also relate to a non-transient computer readable medium configured to carry out any one of the methods disclosed herein. The application can be a set of instructions readable by a processor and stored on the non-transient computer readable medium. Such medium may be permanent or semi-permanent memory such as hard drive, floppy drive, optical disk, flash memory, ROM, EPROM, EEPROM, etc., as would be known to those of ordinary skill in the art.

In embodiments of the present invention, user interact with the systems using electronic devices. Software that local on the device and/or remote on computers (e.g., servers) is implemented to carryout the desired functionality. The electronic devices can be mobile telephonic devices such as cell phones, smart phones, and personal digital assistants (PDAs), or other devices that can communicate over a telecommunications network or Internet including the world wide web. The electronic devices can also be laptop or notebook computers that can also communicate over a telecommunications network or the internet including the world wide web.

The electronic devices can comprise random access memory (RAM), and non-transient computer readable medium that may be permanent and/or semi-permanent memory such as CMOS memory, and flash memory or EEPROM. The electronic devices can also comprise a processor that can that can read the instructions that from a computer readable medium and cause the electronic device to perform the steps of the different embodiments of the invention and to carry out any one of the methods disclosed herein. The electronic device can also comprise the electronics necessary for communication over a telephone or computer network as would be known in the art.

In some embodiments, a server can comprise at least one computer acting as a server as would be known in the art. The server(s) can be a plurality of the above mentioned electronic and server devices operating as a virtual server, or a larger server operating as a virtual server which may be a virtual machine, as would be known to those of ordinary skill in the art. Such possible arrangements of computer(s), distributed resources, and virtual machines can be referred to as a server or server system. Cloud computing also for example contemplated.

Although this present invention has been described in considerable detail with reference to certain preferred versions thereof, other embodiments are possible. Therefore, the spirit and scope of the invention should not be limited to the description of the preferred embodiments contained herein. In addition, the examples provided each describe a particular number of steps, however, more or less steps and variations of the above described order are also contemplated, and should be considered within the principles and scope of the invention.

It should be understood by those of ordinary skill in the art of computers and telecommunications that the communications illustratively described herein typically include forming messages, packets, or other electronic signals that carry data, commands, or signals, to recipients for storage, processing, and interaction. It should also be understood that such information is received and stored, such as in a database, using electronic fields and data stored in those fields.

It is understood that discussion of a system will also reflect a process or computer readable medium that is implemented on or as part of that system.

A player is typically being used to refer a real-life football player, group of players, or offensive or defensive side unless the context indicates otherwise.

Software can be implement on one or more devices or components in providing these features.

It is evident that some of the features provide the system with functionality to limit the situation or performance that will give a team owner points from a player's performance in a game or event such that the qualified activity is the performance that the owner receives points from.

In some instances above, as is evident, the description is provided from the user's perspective to describe the system features or processes that are configured to provides those features or processes.

As is generally known, the fantasy games implement processes in which fantasy owner's earn fantasy point that correspond to the actual player performance of a player or team unit in an actual game. The owners are in a fantasy league and typically have a season in which there weekly matchup between team owners in a league.

The present systems are particularly suitable to fantasy football but it will be understood depending on the context and feature that some, but not all of the described fantasy football feature can be applicable to other electronic interactive fantasy sports application. However, their significance may vary given variations between football and other games and the basic fantasy game itself

It is to be understood that some or all of the above described features, components and method steps can be combined in different ways, and other variations and modifications other than those illustrated will be apparent to persons of ordinary skill in the art. In particular, the various embodiments of the present invention may be implemented with other choices of hardware, and software distributed over the different hardware components or within a computing cloud, as well as the storage and processing of the data, according to the embodiments and criteria stated above. Each and every one of these permutations and combinations is separately deemed to be an embodiment herein in its own right, and engineering requirements and/or governing code appropriate for transmission and communication between the components, as well as the implementation of the application(s), will govern the use and deployment of the said embodiments and establish separate embodiments herein such that each and every one is its own embodiment. It is therefore intended that all of these embodiments, examples, variations and modifications thereon are meant to be encompassed within the spirit and scope of the present invention as set forth in the following claims

What is claimed is:

1. A system that implements an interactive electronic fantasy football game comprising one or more computers that provide or implement one or more fantasy football features, comprising one or more computers that provide or implement a specialized clutch point complement to basic point system in which the point system awards points for clutch plays, wherein the system evaluates the state of the game in accordance with the point difference between the teams, the down, game period (half, quarter or overtime), official time left in the game or half, other in-game context imparting significance compared to other in-game events, or combinations thereof and data representative of the play and determines that the state and data contains significant characteristic representative of a valued actual play or team unit performance, wherein the system generates an output such as points or a display signal in response to the determination.
